(19) United States
(12) Patent Application Publication
(10) Pub. No.: US 2018/0359011 A1
(43) Pub. Date: Dec. 13, 2018

(54) COLLABORATIVE BEAMFORMING AND SCHEDULING IN A WIRELESS NETWORK

(71) Applicant: Intel IP Corporation, Santa Clara, CA (US)

(72) Inventors: Roya Doostnejad, Los Altos, CA (US); Carlos Aldana, Mountain View, CA (US); Laurent Cariou, Portland, OR (US)

(21) Appl. No.: 15/621,049

(22) Filed: Jun. 13, 2017

(51) Int. Cl. H04B 7/06; H04W 88/08; H04W 16/28; H04W 72/12; H04W 72/04

(52) U.S. Cl. CPC H04B 7/0617; H04W 88/08; H04W 72/046; H04W 72/1231; H04W 72/1252; H04W 16/28

(57) ABSTRACT

In a dense wireless environment with spatial diversity and with multiple access points (APs) and multiple users (STAs), a common network controller may be used to determine which AP-STA combinations can operate simultaneously over the same channel without interfering with other AP-STA combinations. Each STA associates with each AP in a way that derives directionality, signal strength, array weight vectors, etc., for that AP and then provides that information to that AP. Each AP collects similar information from every STA in the network, and forwards the collected information to a Central Controller, who uses the combined information from all APs to determine which AP-STA combinations may operate simultaneously without causing interference with each other.

### TECHNICAL FIELD OF THE INVENTION

Various embodiments described herein deal generally with wireless communications, particularly with wireless communications networks that use directional links.

### BACKGROUND

As wireless local area networks increase in density, complexity, and throughput demands, the established approaches and designs are becoming increasingly unable to keep up with the throughput demands. Increasing the basic band to 60 GHz has already been used to increase the potential data rate over each link. Using directional communications has also been used to permit a single access point (AP) to communicate with different user stations (STAs) in different directions at the same time using the same frequency, thereby increasing overall throughput within a single network. Another way that has been suggested is to place more APs within a given space so that their respective networks overlap in location, permitting more STAs and APs to exist in a smaller geographical space. However, when using conventional techniques this has two disadvantages: 1) each STA can only communicate directly with its own AP unless it goes through a new association process to find a new AP, and 2) different APs may not be able to communicate with their STAs at the same time on the same channel without interfering with each other.

### BRIEF DESCRIPTION OF THE DRAWINGS

Some embodiments of the invention may be better understood by referring to the following description and accompanying drawings that are used to illustrate embodiments of the invention. In the drawings:

FIG. 1 shows a diagram of a wireless communications device, according to an embodiment of the invention.

FIG. 2 shows a diagram of a wireless communications network, according to an embodiment of the invention.

FIG. 3 shows a flow diagram of a method performed by a STA, according to an embodiment of the invention.

FIG. 4 shows a flow diagram of a method performed by an AP, according to an embodiment of the invention.

FIG. 5 shows a flow diagram of a method performed by a Central Controller, according to an embodiment of the invention.

FIG. 6 shows a diagram of directional links in a network, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The term “wireless” may be used to describe circuits, devices, systems, methods, techniques, communications channels, etc., that communicate data by using modulated electromagnetic radiation through a non-solid medium. A wireless device may comprise at least one antenna, at least one radio, at least one memory, and at least one processor, where the radio(s) transmits signals through the antenna(s) that represent data and receives signals through the antenna(s) that represent data, while the processor(s) may process the data to be transmitted and the data that has been received. The processor(s) may also process other data which is neither transmitted nor received.

As used within this document, the term “access point” (AP) is intended to cover wireless communication devices that schedule and control, at least partially, wireless communications by other wireless communication devices in the network. An AP may also be known as a base station (BS), central point (CP), PBSS control point (PCP) or any other term that may arise to describe the functionality of an AP.

As used within this document, the term “STA” is intended to cover those wireless communications devices whose wireless communications are at least partially scheduled and controlled by an AP. A STA may also be known as a mobile station (MS), subscriber station (SS), user equipment (UE), or any other term that may arise to describe the functionality of a STA. STAs may move during such communications, but movement is not required.

As used within this document, the term “communicate” is intended to include transmitting and/or receiving. This may be particularly useful in claims when describing the organization of data that is being transmitted by one device and received by another, but the claim can be interpreted to cover the functionality of either one of those devices. Similarly, the bidirectional exchange of data between two devices (both devices transmit and receive during the exchange) may be described as ‘communicating’, even if the functionality of only one of those devices is being claimed.

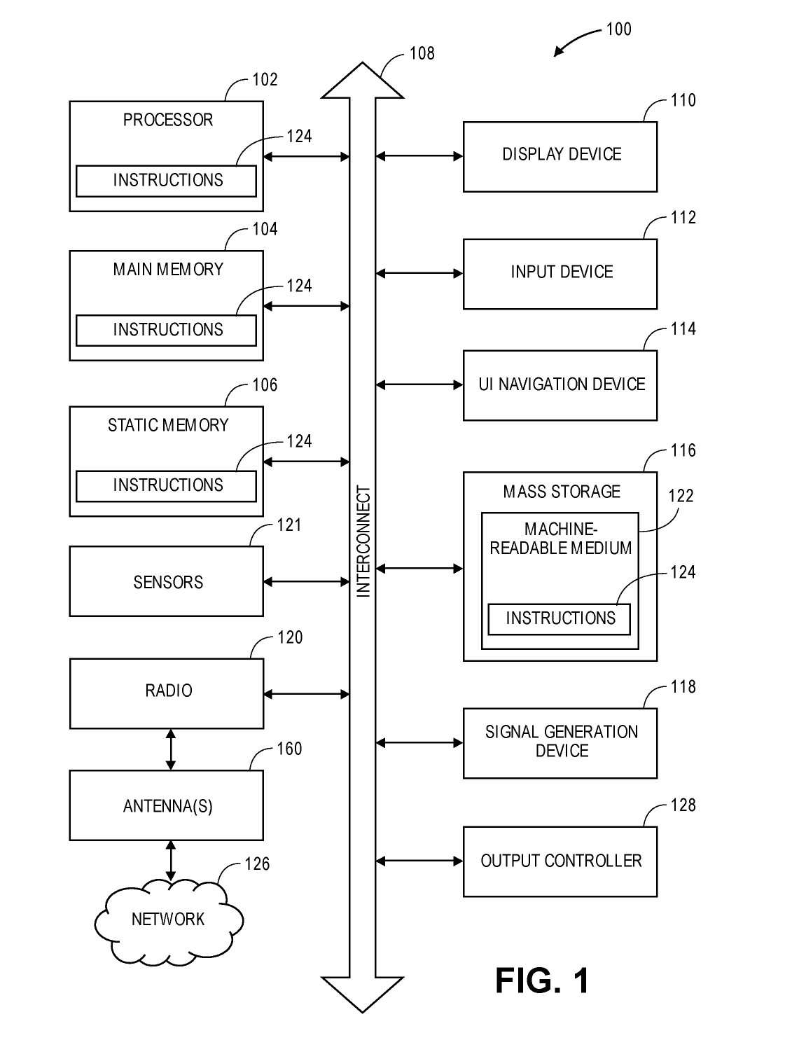

FIG. 1 shows a diagram of a wireless communications device, according to an embodiment of the invention. The embodiments of device 100 may represent any of the wireless communication devices described elsewhere in this document. The elements of device embodiment 100 are shown as an example, but other wireless devices may have more, fewer, or different features. Device 100 is shown with one or more antennas 160, one or more radios 120, one or more processors 102, one or more memories 104 and/or 106. In addition, device 100 is shown with sensors 121, a display 110, an input device 112, a UI navigation device 114, a mass storage 116, a signal generation device 118, an output controller 128, and may also contain other components. These components may be coupled together in any feasible manner, for example over interconnect 108. FIG. 1 also shows a network 226, over which device 100 may communicate wirelessly with other devices.

Various embodiments of the invention may be implemented fully or partially in software and/or firmware. This software and/or firmware may take the form of instructions (e.g., instructions 124) contained in or on a non-transitory computer-readable storage medium (e.g., medium 122, main memory 104, and/or static memory 106). The medium may also be external to device 100, with the intention that the instructions will eventually be loaded into, and executed by, a device such as device 100. The instructions may be read and executed by the one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing instructions and/or other information in a form readable by one or more computers, such as but not limited to read only memory (ROM); random access memory (RAM); magnetic disk storage media; optical storage media; a flash memory, etc.

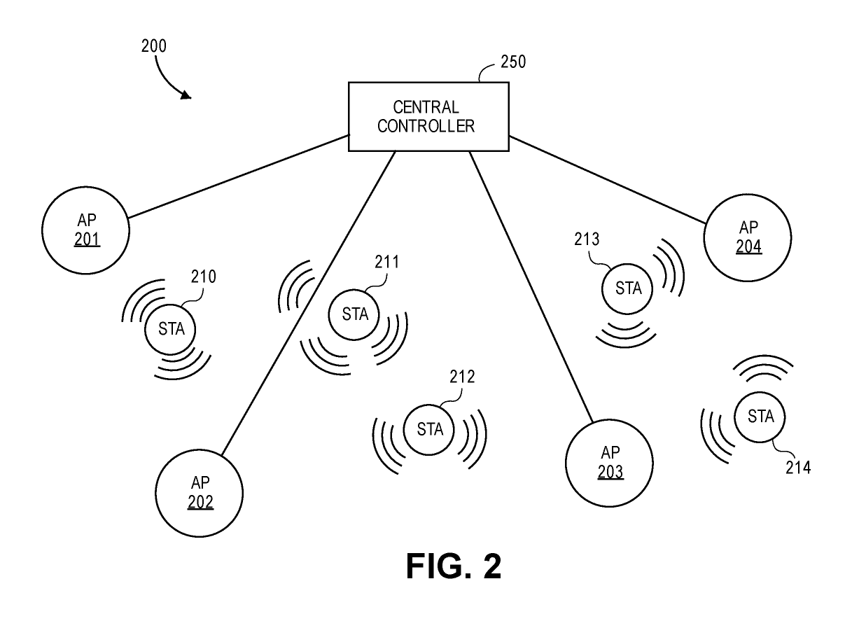

FIG. 2 shows a diagram of a wireless communications network 200, according to an embodiment of the invention. As the term is used herein, a ‘network’ may include a Central Controller, the APs communicating with that Central Controller, and the STAs communicating with those APs. In the illustrated embodiment, multiple APs (e.g., 201, 202, 203, 204) may each have a communications link with a Central Controller 250. These links may be either wireless or hardwired. Central Controller 250 may serve various purposes, such as but not limited to passing information between the APs, synchronizing timing between the APs, acting as a gateway to networks not shown in FIG. 2, analyzing data regarding the APs and STAs, and making decisions about the operation of the APs and STAs.

As can be seen in FIG. 2, each of STAs 210, 211, 212, 213, 214 may communicate with multiple APs. In fact, in this example, each STA 210-214 should be considered to be able to communicate with every AP 201-204. This is in contrast with conventional networks, in which each STA associates with only one AP, and then becomes effectively tied to that AP to the exclusion of other APs.

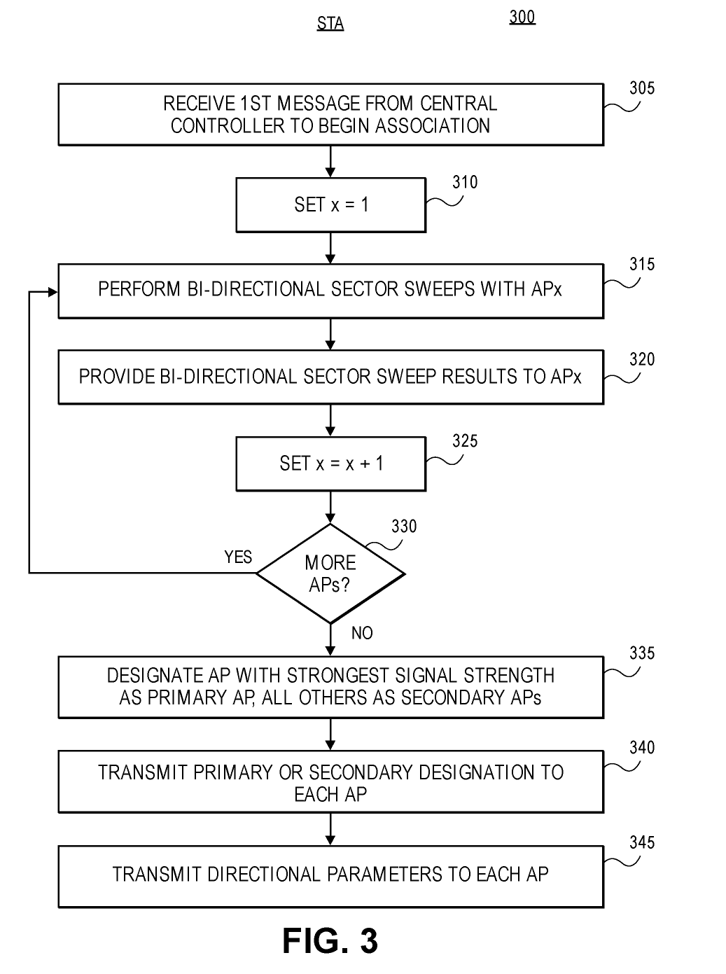

FIG. 3 shows a flow diagram 300 of a method that may be performed by an example STA, according to an embodiment of the invention. This method may be followed by each of multiple STAs in the network. In the indicated flow, ‘x’ increments through multiple iterations to indicate that the STA is performing the same functions with multiple APs, labeled as APx. Each STA in the network may separately perform the operations of FIG. 3.

Starting with a description of a single STA, the STA may receive a 1^{st} message from the Central Controller at 305 directing the STA to begin directional training with multiple APs in the network. In some embodiments, this message may identify all APs and STAs that are to take part in collaborative beamforming. A value ‘x’ may be set to ‘1’ at 310 to indicate that operations 315 and 320 will be performed by interacting with a first AP. At 315 this STA may perform bi-directional sector sweeps with that AP.

As the term is used herein, in a bi-directional sector sweep a STA may transmit directionally in sectors covering 360 degrees, with a sector ID contained in each one. The AP may then transmit a response identifying which of those sectors provided the best signal. Then the AP may transmit directionally in its own sectors, and the STA may transmit a response identifying which of the AP sectors provided the best signal. In this manner, the STA can determine which of its own sectors is pointed at the AP, and the AP can determine which of its own sectors is pointed at the STA. At 320 the STA may provide the sector sweep results that it determined in this process to the AP. In this manner, the AP will have the directional information for both devices for a directional link between these two devices.

The value of ‘x’ may then be incremented at 325 to select a second AP that the STA can communicate with, and determine at 330 if there is a second AP in the network with which this STA has not performed a bi-directional sector sweep. If there is, the STA may return to 315 to perform the operations at 315 and 320 on the second AP. It should be noted that the value of ‘x’ is not necessarily a program function performed by the STA, but is merely an artificial value used within this flow diagram to indicate which AP is being considered.

Once the STA has performed the operations at 315 and 320 with all the available APs within the network, as determined at 330, the STA may examine its own chosen sector for each AP in the network. Based on this examination, it may designate one of those APs as its primary AP at 335, while designating all the other APs as secondary. Various criteria may be used for this designation. In one embodiment, the AP that showed the strongest received signal strength (RSS) at the STA during the bi-directional sector sweeps may be selected as the designated primary AP at 335. In another embodiment, signal-to-interference-and-noise-ratio (SINR) criteria may be used instead of RSS. Other criteria may be used as well. At 340, the STA may communicate to each AP whether that AP has been designated as a primary or secondary AP for this STA. At 345, the STA may communicate to each AP the directional parameters that were determined during the sector sweeps with that that AP.

It should be noted that in this document, the term ‘primary’ is used to indicate a relationship between an AP and a STA in which they have undergone a pre-association process and established a directional link, and the AP subsequently performs the normal AP functions of scheduling and control with that STA. The term ‘secondary’ is used to indicate a relationship between an AP and a STA in which they have undergone a pre-association process and established a directional link, but the AP is not to then perform the normal functions of scheduling and control with that STA, and is not to communicate directly with that STA. However, the pre-association process may provide enough information that the ‘secondary’ status of the AP may be changed to ‘primary’ quickly and dynamically.

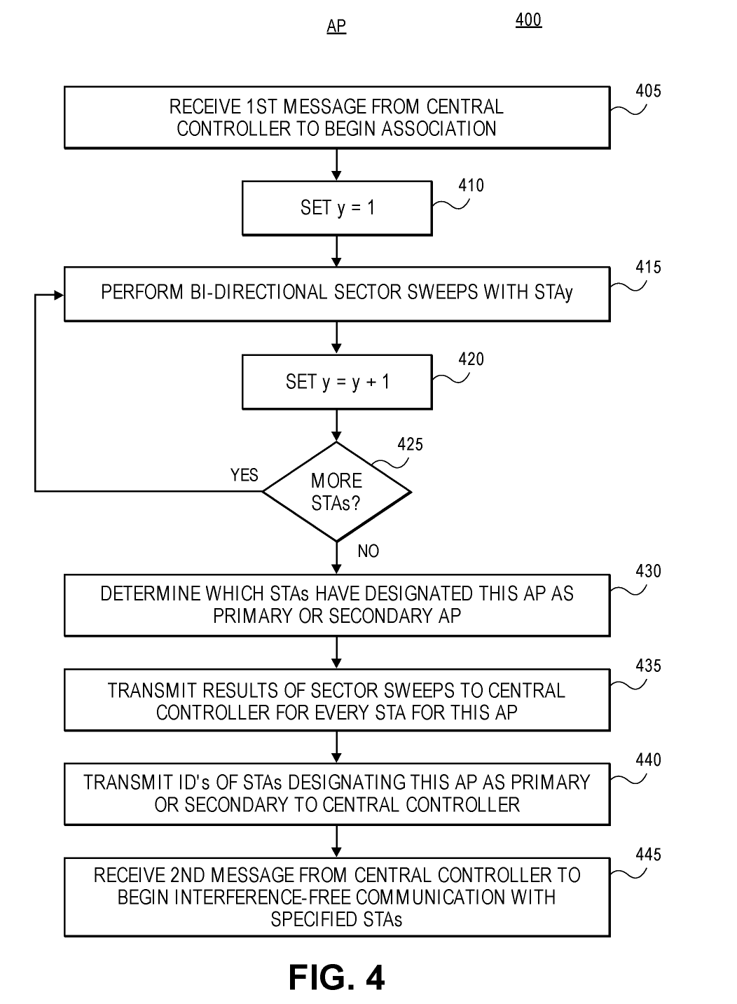

FIG. 4 shows a flow diagram 400 of a method that may be performed by an example AP, according to an embodiment of the invention. This method 400 may be followed by each of multiple APs in network. In the indicated flow, ‘y’ increments through multiple iterations to indicate that the AP is performing the same functions with multiple STAs, labeled as STAy. Each AP in the network may separately perform the operations of FIG. 4.

Starting with a description of a single AP, the AP may receive a 1^{st} message from the Central Controller at 405 directing the STA to begin directional training with multiple STAs in the network. In some embodiments, this message may identify all the APs and STAs that are to take part in collaborative beamforming. A value ‘y’ may be set to ‘1’ at 410 to indicate that operation 415 may be performed by interacting with a first STA. At 415 this AP may perform bi-directional sector sweeps with that STA, so that the AP can determine which of its own sectors is pointed at the STA, and the STA can determine which of its own sectors is pointed at the AP.

The value of ‘y’ may then be incremented at 420, and determine at 425 if there is another STA in the network with which this AP has not already performed a bi-directional sector sweep. If there is, the AP may return to 415 to perform the bi-directional sector sweep again with the new STA. It should be noted that the value of ‘y’ is not necessarily a program function performed by the AP, but is merely an artificial value used within this flow diagram to indicate which STA is being considered.

Once the AP has performed the operations at 415 and 420 with all the available STAs within the network, as determined at 425, it may move to 430 to determine which STAs in the network have designated this AP as their primary AP, and which STAs have designated this AP as secondary. This information may be communicated to the AP by each STA in the network after that STA makes its own determination. At 435, the AP may transmit the results of the sector sweeps with every STA to the Central Controller. These results may include the AP sector, STA sector, and antenna weight vector for each AP-STA directional link.

At 440, the AP may transmit to the Central Controller the IDs of the STAs that have designated it as a primary AP, and the IDs of the STAs that have designated it as a secondary AP. Since each STA makes this determination for itself, a single AP may have several STAs that have designated it as primary. In some embodiments, the primary AP designations and sector sweep results may be transmitted together by the AP.

At 445 the AP may receive a second message from the Central Controller to begin directional communication with one or more of its specified primary STAs, along with timing information about when the communication should take place. This message may be received after the Central Controller has had time to perform an analysis on all the results from all the APs and STAs in the network (see subsequent description of process for Central Controller). The array weight vectors for directional links to those STAs may already be known by the AP from the earlier sector sweep processes. These communications should be such that no interference will occur with any other simultaneous communications from any other APs with their own primary STAs. However, since the Central Controller has already calculated which APs can communicate simultaneously without interference, and constructed the second message with that goal, the APs themselves need not be concerned with avoiding interference with each other.

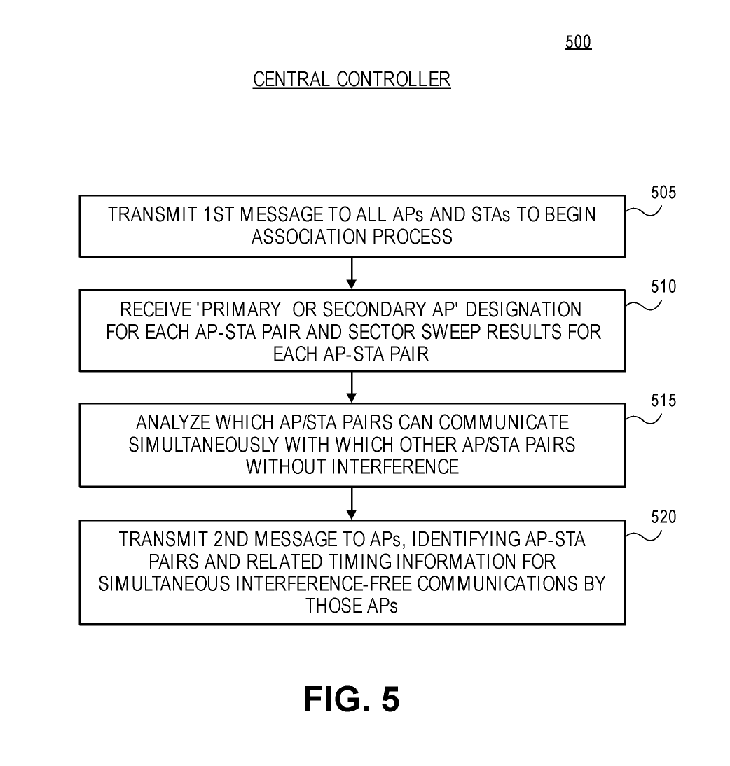

FIG. 5 shows a flow diagram 500 of a method that may be performed by a network controller, according to an embodiment of the invention. At 505, the Central Controller may transmit a message to all APs and STAs to begin the directional training process described for FIGS. 3 and 4. This message may be in various forms, such as for instance, a broadcast message. At 510, the Central Controller may receive from each AP an indication of which STAs have designated that AP as a primary AP, and may further receive the results of the sector sweep results for each AP-STA pair in the network. Based on this information, the Central Controller may perform an analysis at 515 to determine which AP-STA pairs may communicate with each other simultaneously with which other AP-STA pairs without the risk of interference. Once this determination has been made, the Central Controller should have a database of permissible simultaneous communications within the network.

At 520, the Central Controller may transmit message(s) to the APs, indicating which AP-STA pair may communicate at the same time as which other AP-STA pair. In some embodiments, the APs do not communicate with each other directly and therefore a first AP cannot know whether its communication with its (first) STA is scheduled at the same time as a second AP's communication with its (second) STA. In such a case, the Central Controller may provide the first AP with timing information as to when it can communicate with the first STA, and may also provide the second AP with timing information as to when it can communicate with the second STA. In this scenario, each AP may not know what other APs are to communicate at the same time, it may only know the timing slots it has been given by the Central Controller.

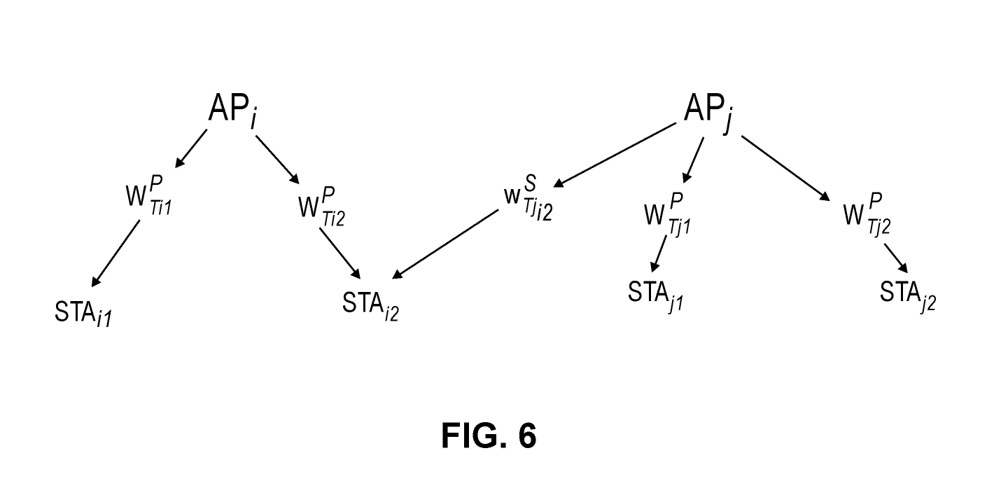

FIG. 6 shows a diagram of directional links in a network of two APs and four STAs, according to an embodiment of the invention. In one embodiment, the analysis performed by the Central Controller at 515 to determine interference may be described by the following operations, which can be better understood by referring to FIG. 6. For this example, the following terminology may be used, with two APs, and two STAs per AP. The following terminology is used in this explanation:
APᵢ is the primary AP for STAᵢ₁, with a transmit beam sector matrix (i.e., the AP transmit sector directed at the STA) represented by W^{P}_{Ti1}. APᵢ is also the primary AP for STAᵢ₂, with a transmit beam sector matrix represented by W^{P}_{Ti2}.
APⱼ is the primary AP for STAⱼ₁, with a transmit beam sector matrix represented by W^{P}_{Tj1}. APⱼ is also the primary AP for STAⱼ₂, with a transmit beam sector matrix represented by W^{P}_{Tj2}.
APⱼ is the secondary AP for STAᵢ₂, with a transmit beam sector matrix represented by w^{S}_{Tji2}. (A lower case w represents a secondary channel). APj is also the secondary AP for STAᵢ₁, although the directional link between them is not seen in FIG. 6.

A signature for an interference channel between APⱼ and STAᵢ₂ may be represented by h^{j}ᵢ₂=(w^{S}_{Tji2})′.

A signature for the interference channel between APⱼ and each STA associated primarily to APᵢ is estimated using the beam selected at APⱼ for these STAs as w^{S}_{Tjim}′, m=1,2. The same applies for interference estimation from APᵢ transmission to STAⱼ₁, STAⱼ₂, though these interference channels are not shown in FIG. 6.

The interference received at every STA is a result of transmissions from its secondary APs to their own primary STAs (each in the direction W^{P}_{T} towards those primary STAs). The total interference at a STA from all secondary APs may be expressed as the sum of the interferences received by the STA from each of those secondary APs. Based on this, the interference power I^{j}_{il(l=1,2)} received at each primary STA of APᵢ, as a result of APᵢ transmission may be approximated by

I^{j}ᵢₗ≤Σ²ₘ₌₁pₘ/pₗ·|h^{j}ᵢₗ×W^{P}_{Tjm}|²

where P represents transmit power from the AP as allocated to each STA l and m.

In some instances, the link between a STA and its primary AP may become inadequate to maintain reliable communications over that link, even without interference. This may occur for various reasons, such as but not limited to blockage of the signal by an intervening object. Within this document, a report to the Central Controller of such an occurrence is referred to as a blockage report. Upon receipt of a blockage report, the Central Controller may assign a new primary AP to the STA, using the previously received parameters for other secondary AP links with that STA.

### EXAMPLES

The following examples pertain to particular embodiments:

Example 1 includes a method of wireless communications by a wireless station (STA), comprising: receiving a message from a central controller to perform collaborative beamforming; performing a first bi-directional sector sweep with a first access point (AP) to determine information defining a first direction of the first AP from the STA and to determine a first set of communication performance parameters associated with the first direction; performing a second bi-directional sector sweep with a second access point AP to determine information defining a second direction of the second AP from the STA and to determine a second set of communication performance parameters associated with the second direction; selecting the first AP a primary AP for the STA and the second AP as a secondary AP for the STA, based on the first and second performance parameters; transmitting, to the first AP, the first set of performance parameters and information indicating the selection of the first AP as the primary; and transmitting, to the second AP, the second set of performance parameters and the selection of the second AP as the secondary AP.

Example 2 includes the method of example 1, wherein the first set of communication performance parameters includes received signal strength at the first STA.

Example 3 includes the method of example 1, wherein the first set of communication performance parameters includes a channel quality index for the first STA.

Example 4 includes a computer-readable non-transitory storage medium that contains instructions, which when executed by one or more processors result in performing operations comprising: receiving a message from a central controller to perform collaborative beamforming; performing a first bi-directional sector sweep with a first access point (AP) to determine information defining a first direction of the first AP from the STA and to determine a first set of communication performance parameters associated with the first direction; performing a second bi-directional sector sweep with a second access point AP to determine information defining a second direction of the second AP from the STA and to determine a second set of communication performance parameters associated with the second direction; selecting the first AP a primary AP for the STA and the second AP as a secondary AP for the STA, based on the first and second performance parameters; transmitting, to the first AP, the first set of performance parameters and information indicating the selection of the first AP as the primary; and transmitting, to the second AP, the second set of performance parameters and the selection of the second AP as the secondary AP.

Example 5 includes the medium of example 4, wherein the first set of communication performance parameters includes received signal strength at the first STA.

Example 6 includes the medium of example 4, wherein the first set of communication performance parameters includes a channel quality index for the first STA.

Example 7 includes a wireless communications station (STA) having a processor and memory, the processor and memory adapted to: receive a message from a central controller to perform collaborative beamforming; perform a first bi-directional sector sweep with a first access point (AP) to determine information defining a first direction of the first AP from the STA and to determine a first set of communication performance parameters associated with the first direction; perform a second bi-directional sector sweep with a second access point AP to determine information defining a second direction of the second AP from the STA and to determine a second set of communication performance parameters associated with the second direction; select the first AP a primary AP for the STA and the second AP as a secondary AP for the STA, based on the first and second performance parameters; transmit, to the first AP, the first set of performance parameters and information indicating the selection of the first AP as the primary; and transmit, to the second AP, the second set of performance parameters and the selection of the second AP as the secondary AP.

Example 8 includes the STA of example 7, wherein the first set of communication performance parameters is to include received signal strength at the STA.

Example 9 includes the STA of example 7, wherein the first set of communication performance parameters is to include a channel quality index for the STA.

Example 10 includes the STA of example 7, wherein the STA further comprises at least one antenna coupled to the processor and memory.

Example 11 includes a wireless communications station (STA) having means to perform operations comprising: receiving a message from a central controller to perform collaborative beamforming; performing a first bi-directional sector sweep with a first access point (AP) to determine information defining a first direction of the first AP from the STA and to determine a first set of communication performance parameters associated with the first direction; performing a second bi-directional sector sweep with a second access point AP to determine information defining a second direction of the second AP from the STA and to determine a second set of communication performance parameters associated with the second direction; selecting the first AP a primary AP for the STA and the second AP as a secondary AP for the STA, based on the first and second performance parameters; transmitting, to the first AP, the first set of performance parameters and information indicating the selection of the first AP as the primary; and transmitting, to the second AP, the second set of performance parameters and the selection of the second AP as the secondary AP.

Example 12 includes the STA of example 11, wherein the first set of communication performance parameters is to include received signal strength at the STA.

Example 13 includes the STA of example 11, wherein the first set of communication performance parameters is to include a channel quality index for the STA.

Example 14 includes the STA of example 11, further comprising antenna means.

Example 15 includes a method of wireless communications by an access point (AP), comprising: receiving a first message from a central controller to begin collaborative beamforming; performing a first bi-directional sector sweep with a first station (STA); receiving information from the first STA indicating a first direction of the first STA from the AP and containing communication performance parameters associated with the first direction; performing a second bi-directional sector sweep with a second STA; receiving information from the second STA indicating a second direction of the second STA from the AP and containing communication performance parameters associated with the second direction; receiving information from the first STA identifying the AP as a primary AP for the first STA; receiving information from the second STA identifying the AP as a secondary AP for the second STA; transmitting, to the central controller, information identifying the AP as the primary AP for the first STA and identifying the AP as the secondary AP for the second STA; and transmitting, to the central controller, information containing the performance parameters associated with the first and second directions.

Example 16 includes the method of example 15, wherein the communication performance parameters include received signal strength at the first STA.

Example 17 includes the method of example 15, wherein the communication performance parameters include a channel quality index for the first STA.

Example 18 includes a computer-readable non-transitory storage medium that contains instructions, which when executed by one or more processors result in performing operations comprising: receiving a first message from a central controller to begin collaborative beamforming; performing a first bi-directional sector sweep with a first station (STA); receiving information from the first STA indicating a first direction of the first STA from the AP and containing communication performance parameters associated with the first direction; performing a second bi-directional sector sweep with a second STA; receiving information from the second STA indicating a second direction of the second STA from the AP and containing communication performance parameters associated with the second direction; receiving information from the first STA identifying the AP as a primary AP for the first STA; receiving information from the second STA identifying the AP as a secondary AP for the second STA; transmitting, to the central controller, information identifying the AP as the primary AP for the first STA and identifying the AP as the secondary AP for the second STA; and transmitting, to the central controller, information containing the performance parameters associated with the first and second directions.

Example 19 includes the medium of example 18, wherein the communication performance parameters include received signal strength at the first STA.

Example 20 includes the medium of example 18, wherein the communication performance parameters include a channel quality index for the first STA.

Example 21 includes a wireless communications access point (AP) including a processor and memory, the processor and memory adapted to: receive a first message from a central controller to begin collaborative beamforming; perform a first bi-directional sector sweep with a first station (STA); receive information from the first STA indicating a first direction of the first STA from the AP and containing communication performance parameters associated with the first direction; perform a second bi-directional sector sweep with a second STA; receive information from the second STA indicating a second direction of the second STA from the AP and containing communication performance parameters associated with the second direction; receive information from the first STA identifying the AP as a primary AP for the first STA; receive information from the second STA identifying the AP as a secondary AP for the second STA; transmit, to the central controller, information identifying the AP as the primary AP for the first STA and identifying the AP as the secondary AP for the second STA; and transmit, to the central controller, information containing the performance parameters associated with the first and second directions.

Example 22 includes the AP of example 21, wherein the communication performance parameters are to include received signal strength at the first STA.

Example 23 includes the AP of example 21, wherein the communication performance parameters are to include a channel quality index for the first STA.

Example 24 includes the AP of example 21, further comprising an antenna coupled to the processor and memory.

Example 25 includes a wireless communications access point (AP) including means to perform operations comprising: receiving a first message from a central controller to begin collaborative beamforming; performing a first bi-directional sector sweep with a first station (STA); receiving information from the first STA indicating a first direction of the first STA from the AP and containing communication performance parameters associated with the first direction; performing a second bi-directional sector sweep with a second STA; receiving information from the second STA indicating a second direction of the second STA from the AP and containing communication performance parameters associated with the second direction; receiving information from the first STA identifying the AP as a primary AP for the first STA; receiving information from the second STA identifying the AP as a secondary AP for the second STA; transmitting, to the central controller, information identifying the AP as the primary AP for the first STA and identifying the AP as the secondary AP for the second STA; and transmitting, to the central controller, information containing the performance parameters associated with the first and second directions.

Example 26 includes the AP of example 25, wherein the communication performance parameters are to include received signal strength at the first STA.

Example 27 includes the AP of example 25, wherein the communication performance parameters are to include a channel quality index for the first STA.

Example 28 includes the AP of example 25, further comprising antenna means.

Example 29 includes a method of wireless communications by a controller, the method comprising: transmitting a first message to multiple access points (APs) and multiple stations (STAs), the first message directing the multiple APs and STAs to begin collaborative beamforming; receiving primary association information indicating which STA-AP pairs have been designated as having a primary association; receiving secondary association information indicating which STA-AP pairs have been designated as having a secondary association; receiving directional parameter information indicating directional parameters for each primary and secondary association; analyzing the primary association information, the secondary association information, and the directional parameter information to determine which pairs of APs and STAs can communicate simultaneously without interference; and transmitting a second message to multiple access points directing particular pairs of APs and STAs to communicate simultaneously.

Example 30 includes the method of example 29, wherein said analyzing comprises: determining interference received at a first of the multiple STAs as a result of a sum of transmissions from secondary APs of the first STA, the transmission of each of the secondary APs directed towards a primary STA of said each secondary AP.

Example 31 includes the method of example 29, wherein said analyzing further comprises receiving a blockage report from a particular AP, and re-assigning a primary AP-STA pairing as a result of said receiving the blockage report.

Example 32 includes a computer-readable non-transitory storage medium that contains instructions, which when executed by one or more processors result in performing operations comprising: transmitting a first message to multiple access points (APs) and multiple stations (STAs), the first message directing the multiple APs and STAs to begin collaborative beamforming; receiving primary association information indicating which STA-AP pairs have been designated as having a primary association; receiving secondary association information indicating which STA-AP pairs have been designated as having a secondary association; receiving directional parameter information indicating directional parameters for each primary and secondary association; analyzing the primary association information, the secondary association information, and the directional parameter information to determine which pairs of APs and STAs can communicate simultaneously without interference; and transmitting a second message to multiple access points directing particular pairs of APs and STAs to communicate simultaneously.

Example 33 includes the medium of example 32, wherein said analyzing comprises: determining interference received at a first of the multiple STAs as a result of a sum of transmissions from secondary APs of the first STA, the transmission of each of the secondary APs directed towards a primary STA of said each secondary AP.

Example 34 includes the medium of example 32, wherein said analyzing further comprises receiving a blockage report from a particular AP, and re-assigning a primary AP-STA pairing as a result of said receiving the blockage report.

Example 35 includes a wireless communications device including a processor and memory, the processor and memory adapted to: transmit a first message to multiple access points (APs) and multiple stations (STAs), the first message directing the multiple APs and STAs to begin collaborative beamforming; receive primary association information indicating which STA-AP pairs have been designated as having a primary association; receive secondary association information indicating which STA-AP pairs have been designated as having a secondary association; receive directional parameter information indicating directional parameters for each primary and secondary association; analyze the primary association information, the secondary association information, and the directional parameter information to determine which pairs of APs and STAs can communicate simultaneously without interference; and transmit a second message to multiple access points directing particular pairs of APs and STAs to communicate simultaneously.

Example 36 includes the device of example 35, wherein the analyzing operation is to determine interference received at a first of the multiple STAs as a result of a sum of transmissions from secondary APs of the first STA, the transmission of each of the secondary APs to be directed towards a primary STA of said each secondary AP.

Example 37 includes the device of example 35, wherein the analyzing operation is further to receive a blockage report from a particular AP, and re-assign a primary AP-STA pairing as a result of said receiving the blockage report.

Example 38 includes the device of example 35, wherein the device is further to comprise an antenna coupled to the processor and memory.

Example 39 includes a wireless communications device having means to perform operations comprising: transmitting a first message to multiple access points (APs) and multiple stations (STAs), the first message directing the multiple APs and STAs to begin collaborative beamforming; receiving primary association information indicating which STA-AP pairs have been designated as having a primary association; receiving secondary association information indicating which STA-AP pairs have been designated as having a secondary association; receiving directional parameter information indicating directional parameters for each primary and secondary association; analyzing the primary association information, the secondary association information, and the directional parameter information to determine which pairs of APs and STAs can communicate simultaneously without interference; and transmitting a second message to multiple access points directing particular pairs of APs and STAs to communicate simultaneously.

Example 40 includes the device of example 39, wherein said means to analyze comprises means to determine interference received at a first of the multiple STAs as a result of a sum of transmissions from secondary APs of the first STA, the transmission of each of the secondary APs directed towards a primary STA of said each secondary AP.

Example 41 includes the device of example 39, wherein said means to analyze further comprises means to receive a blockage report from a particular AP, and re-assigning a primary AP-STA pairing as a result of said receiving the blockage report.

Example 42 includes the device of example 39, further comprising antenna means.

The foregoing description is intended to be illustrative and not limiting. Variations will occur to those of skill in the art. Those variations are intended to be included in the various embodiments of the invention, which are limited only by the scope of the following claims.

What is claimed is:

1. A wireless communications station (STA) including a processor and memory, the processor and memory adapted to:
receive a message from a central controller to perform collaborative beamforming;
perform a first bi-directional sector sweep with a first access point (AP) to determine information defining a first direction of the first AP from the STA and to determine a first set of communication performance parameters associated with the first direction;
perform a second bi-directional sector sweep with a second access point AP to determine information defining a second direction of the second AP from the STA and to determine a second set of communication performance parameters associated with the second direction;
select the first AP as a primary AP for the STA and the second AP as a secondary AP for the STA, based on the first and second performance parameters;
transmit, to the first AP, the first set of performance parameters and information indicating the selection of the first AP as the primary AP; and
transmit, to the second AP, the second set of performance parameters and information indicating the selection of the second AP as the secondary AP.

2. The STA of claim 1, wherein the first set of communication performance parameters is to include received signal strength at the STA.

3. The STA of claim 1, wherein the first set of communication performance parameters is to include a channel quality index for the STA.

4. The STA of claim 1, wherein the STA further comprises at least one antenna coupled to the processor and memory.

5. A computer-readable non-transitory storage medium that contains instructions, which when executed by one or more processors result in performing operations comprising:
receiving a message from a central controller to perform collaborative beamforming;
performing a first bi-directional sector sweep with a first access point (AP) to determine information defining a first direction of the first AP from the STA and to determine a first set of communication performance parameters associated with the first direction;
performing a second bi-directional sector sweep with a second access point AP to determine information defining a second direction of the second AP from the STA and to determine a second set of communication performance parameters associated with the second direction;
selecting the first AP as a primary AP for the STA and the second AP as a secondary AP for the STA, based on the first and second performance parameters;
transmitting, to the first AP, the first set of performance parameters and information indicating the selection of the first AP as the primary AP; and
transmitting, to the second AP, the second set of performance parameters and information indicating the selection of the second AP as the secondary AP.

6. The medium of claim 5, wherein the first set of communication performance parameters includes received signal strength at the first STA.

7. The medium of claim 5, wherein the first set of communication performance parameters includes a channel quality index for the first STA.

8. A wireless communications access point (AP) including a processor and memory, the processor and memory adapted to:
receive a first message from a central controller to begin collaborative beamforming;
perform a first bi-directional sector sweep with a first station (STA);
receive information from the first STA indicating a first direction of the first STA from the AP and containing communication performance parameters associated with the first direction;
perform a second bi-directional sector sweep with a second STA;
receive information from the second STA indicating a second direction of the second STA from the AP and containing communication performance parameters associated with the second direction;
receive information from the first STA identifying the AP as a primary AP for the first STA;
receive information from the second STA identifying the AP as a secondary AP for the second STA;
transmit, to the central controller, information identifying the AP as the primary AP for the first STA and identifying the AP as the secondary AP for the second STA; and
transmit, to the central controller, information containing the performance parameters associated with the first and second directions.

9. The AP of claim 8, wherein the communication performance parameters are to include received signal strength at the first STA.

10. The AP of claim 8, wherein the communication performance parameters are to include a channel quality index for the first STA.

11. The AP of claim 8, further comprising an antenna coupled to the processor and memory.

12. A computer-readable non-transitory storage medium that contains instructions, which when executed by one or more processors result in performing operations comprising:
receiving a first message from a central controller to begin collaborative beamforming;
performing a first bi-directional sector sweep with a first station (STA);
receiving information from the first STA indicating a first direction of the first STA from the AP and containing communication performance parameters associated with the first direction;
performing a second bi-directional sector sweep with a second STA;
receiving information from the second STA indicating a second direction of the second STA from the AP and containing communication performance parameters associated with the second direction;
receiving information from the first STA identifying the AP as a primary AP for the first STA;
receiving information from the second STA identifying the AP as a secondary AP for the second STA;
transmitting, to the central controller, information identifying the AP as the primary AP for the first STA and identifying the AP as the secondary AP for the second STA; and
transmitting, to the central controller, information containing the performance parameters associated with the first and second directions.

13. The medium of claim 12, wherein the communication performance parameters include received signal strength at the first STA.

14. The medium of claim 12, wherein the communication performance parameters include a channel quality index for the first STA.

15. A wireless communications device including a processor and memory, the processor and memory adapted to:
transmit a first message to multiple access points (APs) and multiple stations (STAs), the first message directing the multiple APs and STAs to begin collaborative beamforming;
receive primary association information indicating which STA-AP pairs have been designated as having a primary association;
receive secondary association information indicating which STA-AP pairs have been designated as having a secondary association;
receive directional parameter information indicating directional parameters for each primary and secondary association;
analyze the primary association information, the secondary association information, and the directional parameter information to determine which pairs of APs and STAs can communicate simultaneously without interference; and
transmit a second message to multiple access points directing particular pairs of APs and STAs to communicate simultaneously.

16. The device of claim 15, wherein the analyzing operation is to determine interference received at a first of the multiple STAs as a result of a sum of transmissions from secondary APs of the first STA, the transmission of each of the secondary APs to be directed towards a primary STA of said each secondary AP.

17. The device of claim 15, wherein the analyzing operation is further to receive a blockage report from a particular AP, and re-assign a primary AP-STA pairing as a result of said receiving the blockage report.

18. The device of claim 15, wherein the device is further to comprise an antenna coupled to the processor and memory.

19. A computer-readable non-transitory storage medium that contains instructions, which when executed by one or more processors result in performing operations comprising:
transmitting a first message to multiple access points (APs) and multiple stations (STAs), the first message directing the multiple APs and STAs to begin collaborative beamforming;
receiving primary association information indicating which STA-AP pairs have been designated as having a primary association;
receiving secondary association information indicating which STA-AP pairs have been designated as having a secondary association;
receiving directional parameter information indicating directional parameters for each primary and secondary association;
analyzing the primary association information, the secondary association information, and the directional parameter information to determine which pairs of APs and STAs can communicate simultaneously without interference; and
transmitting a second message to multiple access points directing particular pairs of APs and STAs to communicate simultaneously.

20. The medium of claim 19, wherein said analyzing comprises:
determining interference received at a first of the multiple STAs as a result of a sum of transmissions from secondary APs of the first STA, the transmission of each of the secondary APs directed towards a primary STA of said each secondary AP.

21. The medium of claim 19, wherein said analyzing further comprises receiving a blockage report from a particular AP, and re-assigning a primary AP-STA pairing as a result of said receiving the blockage report.
